(19) United States
(12) Patent Application Publication
(10) Pub. No.: US 2006/0059311 A1
(43) Pub. Date: Mar. 16, 2006

(54) Using a cache miss pattern to address a stride prediction table

(76) Inventors: Jan-Willem Van De Waerdt, Hamburg (DE); Jan Hoogerbrugge, Mt Helmond (NL)

Correspondence Address: PHILIPS INTELLECTUAL PROPERTY & STANDARDS, P.O. BOX 3001, BRIARCLIFF MANOR, NY, 10510, US

(21) Appl. No.: 10/535,591

(22) PCT Filed: Nov. 11, 2003
(86) PCT No.: PCT/IB03/05165

§ 371 Date: May 19, 2005

Related U.S. Application Data
(60) Provisional application No. 60/428,285, filed on Nov. 22, 2002.

(51) Int. Cl. G06F 12/00

(52) U.S. Cl. 711/137; 711/213; 711/217

(57) ABSTRACT

Data prefetching is used to reduce an average latency of memory references for retrieval of data therefrom. The prefetching process is typically based on anticipation of future processor data references. In example embodiment, there is a method of data retrieval that comprises providing a first memory circuit (610), a stride prediction (611) table (SPT) and a cache memory circuit (612). Instructions for accessing data (613) within the first memory are executed. A cache miss (614) is detected. Only when a cache miss is detected is the SPT accessed and updated (615). A feature of this embodiment includes using a stream buffer as the cache memory circuit. Another feature includes using random access cache memory as the cache memory circuit.

This invention relates to the area of data pre-fetching and more specifically in the area of hardware directed pre-fetching of data from memory.

Presently, processors are so much faster than typical RAM that processor stall cycles occur when retrieving data from RAM memory. The processor stall cycles increase processing time to allow data access operations to complete. A process of pre-fetching of data from RAM memory is performed in an attempt to reduce processor stall cycles. Thus, different levels of cache memory supporting different memory access speeds are used for storing different pre-fetched data. When data accessed is other than present within data pre-fetched into the cache memory, a cache miss condition occurs which is resolvable through insertion of processor stall cycles. Further, data that is other than required by the processor but is pre-fetched into the cache memory may result in cache pollution; i.e. removal of useful cache data to make place for non-useful pre-fetched data. This may result in an unnecessary cache miss resulting from the replaced data being sought again by the processor.

Data prefetching is a known technique to those of skill in the art that is used to reduce an average latency of memory references for retrieval of data therefrom. The prefetching process is typically based on anticipation of future processor data references. Bringing data elements from a lower level within the memory hierarchy to a higher level within the memory hierarchy where they are more readily accessible by the processor, before the data elements are needed by the processor, reduces the average data retrieval latency as observed by the processor. As a result, processor performance is greatly improved.

Several prefetching approaches are disclosed in the prior art, ranging from fully software based prefetching implementations to fully hardware based prefetching implementations. Approaches using a mixture of software and hardware based prefetching are known as well. In U.S. Pat. No. 5,822,790, issued to Mehrotra, a shared prefetch data storage structure is disclosed for use in hardware and software based prefetching. Unfortunately, the cache memory is accessed for all data references being made to a data portion of the cache memory for the purposes of stride prediction, thus it would be beneficial to reduce or obviate time consumed by these access operations.

SPT accesses required for stride detection and stride prediction pose a problem. Too many accesses in time may result in processor stall cycles. The problem however may be addressed by making the SPT structure multi-ported, thus allowing multiple simultaneous accesses to the structure. Unfortunately, multi-porting results in an increased die area for the structure, which is of course undesirable.

In accordance with the invention there is provided an apparatus comprising: a stride prediction table (SPT); and, a filter circuit for use with the SPT, the filter circuit for determining instance wherein the SPT is to be accessed and updated, the instances only occurring when a cache miss is detected.

In accordance with the invention there is provided a method of data retrieval comprising the steps of: providing a first memory circuit; providing a striding prediction table (SPT); providing cache memory circuit; executing instructions for accessing data within the first memory; detecting a cache miss; and, accessing and updating the SPT only when a cache miss is detected.

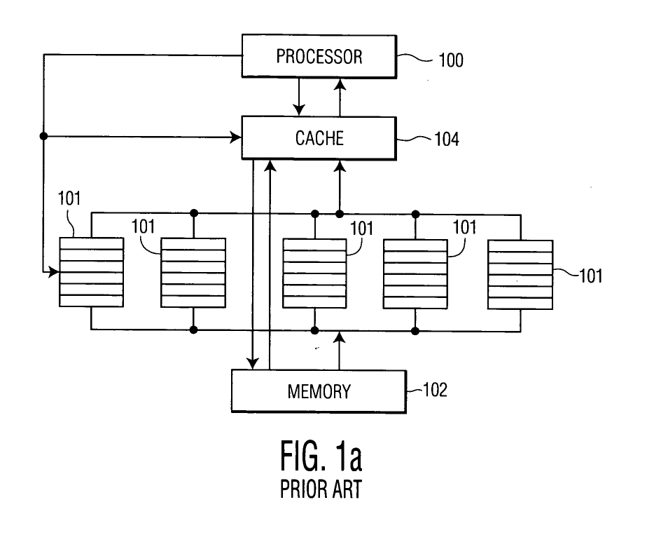

The invention will now be described with reference to the drawings in which: FIG. 1a illustrates a prior art stream buffer architecture; FIG. 1b illustrates a prior art logical organization of a typical single processor system including stream buffers;

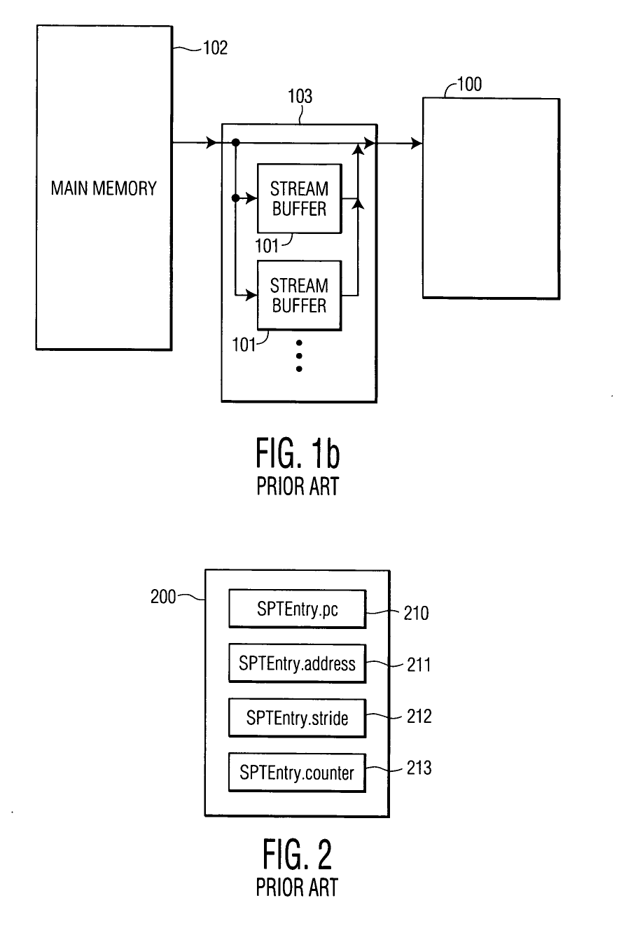

FIG. 2 illustrates a prior art Stride Prediction Table (SPT) made up of multiple entries;

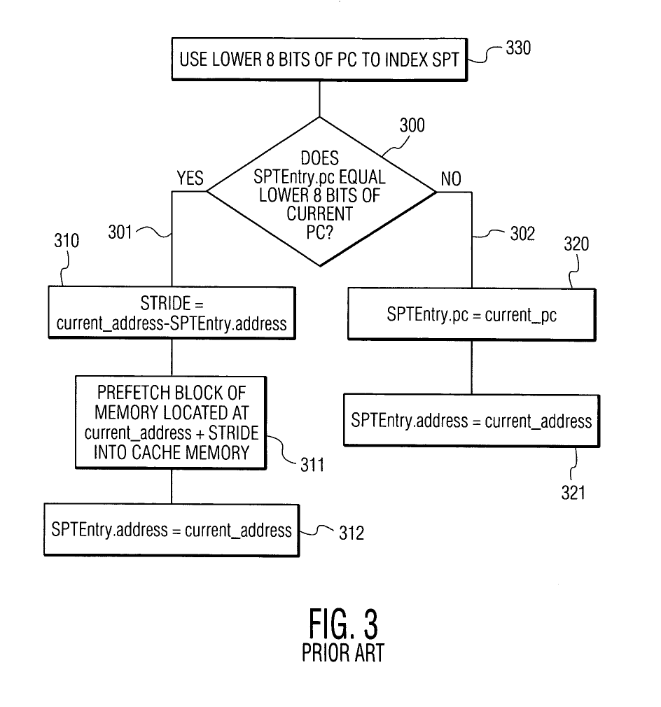

FIG. 3 illustrates a prior art SPT access flowchart with administration tasks;

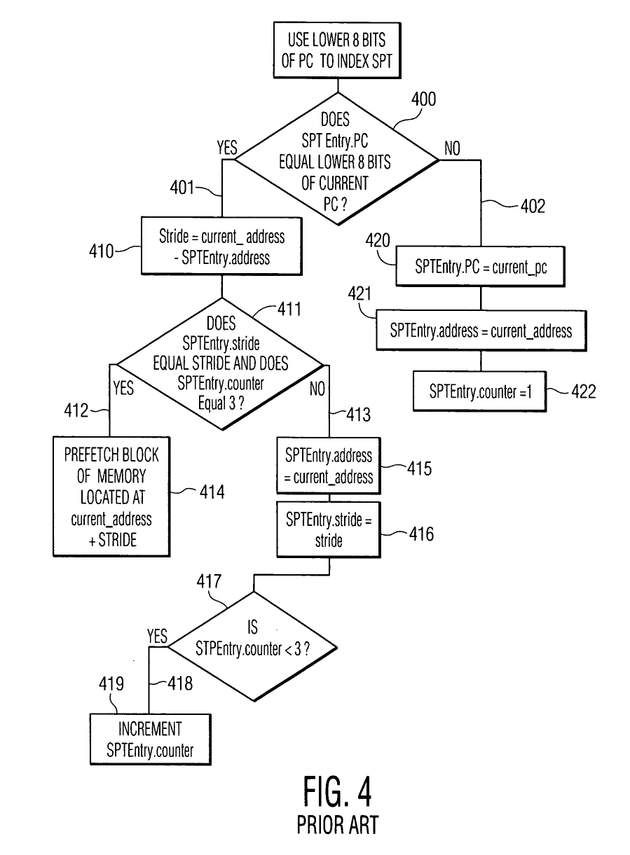

FIG. 4 illustrates a more detailed prior art SPT access flowchart with administration tasks;

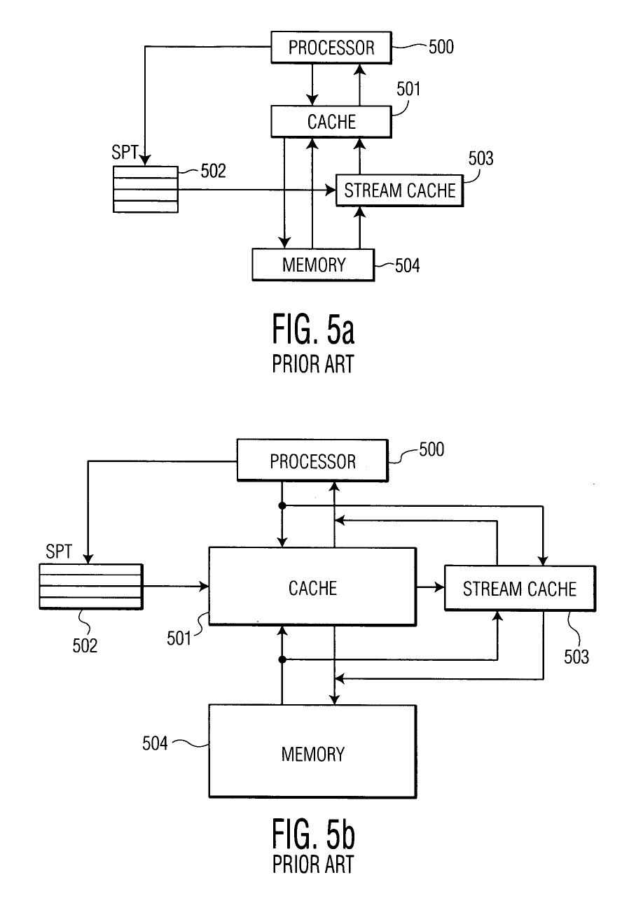

FIG. 5a illustrates a prior art series-stream cache memory;

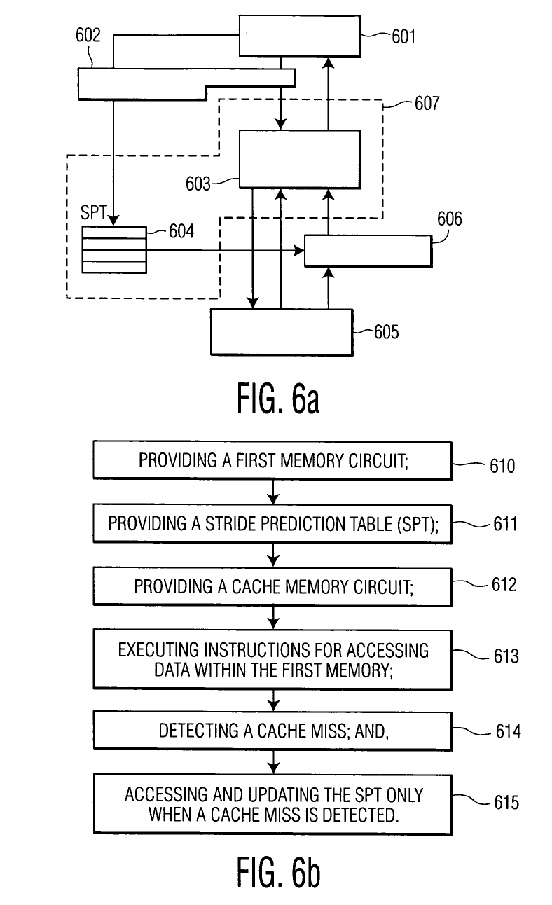

FIG. 5b illustrates a prior art parallel-stream cache memory; FIG. 6a illustrates an architecture for use with an embodiment of the invention;

FIG. 6b illustrates method steps for use in executing of the embodiment of the invention;

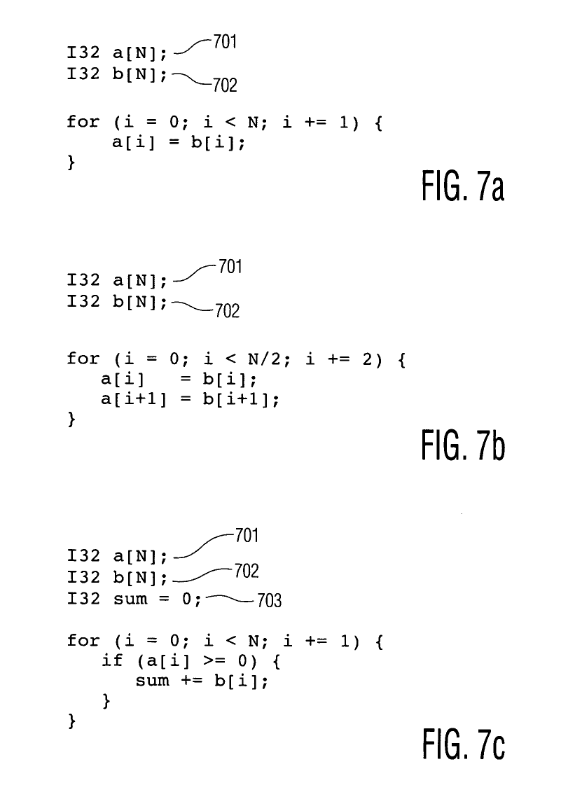

FIG. 7a illustrates a first pseudocode C program including a loop that provides copy functionality for copying of N entries;

FIG. 7b illustrates a second pseudocode C program that provides the same copy functionally as that shown in FIG. 7a; and

FIG. 7c illustrates a pseudocode C program that adds elements from a first array to a second array.

In accordance with an embodiment of the invention a prefetching approach is proposed that combines techniques from the stream buffer approach and the SPT based approach.

Existing approaches for hardware based prefetching include the following prior art. Prior Art U.S. Pat. No. 5,261,066 ('066) issued to Jouppi et al. discloses the concept of stream buffers. Two structures are proposed in the aforementioned patent: a small fully associative cache, also known as a victim cache, which is used to hold victimized cache lines, as well as to address cache conflict misses in low associative or direct mapped cache designs. This small fully associative cache is however not related to prefetching. The other proposed structure is the stream buffer; which is related to prefetching. This structure is typically used to address capacity and compulsory cache misses. In FIG. 1a, a prior art stream buffer architecture is shown.

Stream buffers are related to prefetching, where they are used to store prefetched sequential streams of data elements from memory. In execution of an application stream, to retrieve a line from memory a processor 100 first checks cache memory 104 to determine whether the line is a cache line resident within the cache memory 104. When the line is other than present within the cache memory, a cache miss occurs and a stream buffer 101 is allocated. A stream buffer controller autonomously starts prefetching of sequential cache lines from a main memory 102, following the cache line for which the cache miss occurred, up to the point that the cache line capacity of the allocated stream buffer is full. Thus the stream buffer provides increased processing efficiency to the processor because a future cache line miss is optionally serviced by a prefetched cache line residing in the stream buffer 101. The prefetched cache line is then preferably copied from the stream buffer 101 into the cache memory 104. This advantageously frees up the stream buffer's storage capacity, which makes this memory location within the stream buffer available for use in receiving of a new prefetched cache line. Using a stream buffer, the amount of stream buffers allocated is determined in order to be able to support the amount of data streams that are present in execution within a certain time frame.

Typically, stream detection is based on cache line miss information and in the case of multiple stream buffers, each single stream buffer contains both logic circuitry to detect an application stream and storage circuitry to store prefetched cache line data associated with the application stream. Furthermore, prefetched data is stored in the stream buffer rather than directly in the cache memory.

When there are at least as many stream buffers as data streams, the stream buffer works efficiently. If the amount of application streams is larger than the amount of stream buffers allocated, reallocating of stream buffers to different application streams may unfortunately undo the potential performance benefits realized by this approach. Thus, hardware implementation of stream buffer prefetching is difficult when support for different software applications and streams is desirable. The stream buffer approach also extends to support prefetching with the use of different strides. The extended approach is no longer limited to sequential cache line miss patterns, but supports cache line miss patterns that have successive references separated by a constant stride.

Prior Art U.S. Pat. No. 5,761,706, issued to Kessler et al. builds on the stream buffer structures disclosed in the '066 patent by providing a filter in addition to the stream buffers. Prior Art FIG. 1b illustrates a logical organization of a typical single processor system including stream buffers. This system includes a processor 100, connected to filtered stream buffer module 103 and a main memory 102. Filtered stream buffer module 103 prefetches cache blocks from the main memory 102 resulting in faster service of on-chip misses than in a system with only on-chip caches and main memory 102. The process of filtering is defined for choosing a subset of all memory accesses, which will more likely benefit from use of a stream buffer 101, and allocating a stream buffer 101 only for accesses in this subset. For each application stream a separate stream buffer 101 is allocated as in the prior art '066 patent. Furthermore Kessler et al. disclose both unit stride and non-unit stride prefetching, whereas '066 is restricted to unit stride prefetching.

Another common prior art approach to prefetching relies on a Stride Prediction Table (SPT) 200, as shown in prior art FIG. 2, that is used to predict application streams, as disclosed in the following publication: J. W. Fu, J. H. Patel, and B. L. Janssens, “Stride Directed Prefetching in Scalar Processors,” in Proceedings of the 25^{th} Annual International Symposium on Microarchitecture (Portland, Oreg.), pp. 102-110, December 1992, incorporated herein by reference.

A SPT operation flowchart is shown in FIG. 3. In the SPT approach, application stream detection is typically based on the program counter (PC) and a data reference address of load and store instructions, using a lookup table indexed with the address of the PC. Furthermore, multiple streams are supportable by the SPT 200 as long as they index different entries within the SPT 200. Using the SPT approach; prefetched data is stored directly in a cache memory and not in the SPT 200.

The SPT 200 records a pattern of load and store instructions for data references issued by a processor to a cache memory when in execution of an application stream. This approach uses the PC of these instructions to index 330 the SPT 200. An SPTEntry.pc field 210 in the SPT 200 has a value stored therein for the PC of the instruction that was used to indexed the entry within the SPT, a data references address is stored in an SPTEntry.address field 211, and optionally a stride size is stored in a SPTEntry.stride 212 and a counter value in a SPTEntry.counter field 213. The PC field 210 is used as a tag field to match 300 the PC values of the instructions within the application stream that are indexing the SPT 200. The SPT 200 is made up of a multiple of these entries. When the SPT is indexed with an 8-bit address, there are typically 256 of these entries.

The data reference address is typically used to determine data reference access patterns for an instruction located at an address of a value stored in the SPTEntry.pc field 210. The optional SPTEntry.stride field 212 and SPTEntry.counter field 213 allow the SPT approach to operate with increased confidence when a strided application stream is being detected, as is disclosed in the publication by T.-F. Chen and J.-L. Baer, “Effective Hardware-Based Data Prefetching for High-Performance Processors,” IEEE Transactions on Computer, vol. 44, pp. 609-623, May 1995 incorporated herein by reference.

Of course, the SPT based approach also has its limitations. Namely, typical processors support multiple parallel load and store instruction that are executed in a single processor clock cycle. As a result, the SPT based approach supports multiple SPT administration tasks per clock cycle. In accordance with the flowchart shown in FIG. 3, such an administration task typically performs 2 accesses to the SPT 200. The first access is used to fetch the SPT entry fields 301 and the other access 302 is used to update the entries within the SPT 200. The SPT 200 is indexed using the lower 8 bits of the PC for the application stream, where the lower 8 bits of the PC are compared 300 to the SPTEntry.pc 210 to determine whether they match 301 or not 302.

In fetching the SPT entry fields 301 a stride is determined 310 from a current address and the SPTEntry.address 211, then a block of memory is prefetched 311 from main memory at an address located at the current address plus the stride. Thereafter, the SPTEntry.address 211 is replaced with the current address 312. In the process of updating the entries 302 within the SPT 200, the SPTEntry.pc 210 is updated 320 with the current PC and the SPTEntry.address 211 is updated with the current address 321.

In accordance with the flowchart shown in FIG. 4, SPTEntry.counter and SPTEntry.stride fields are additionally accessed within the SPT 200, where such an administration task typically uses over 2 accesses to the SPT. The first access is used to fetch the SPT entry fields 401 and the other access 402 is used to update the entries within the SPT 200. The SPT 200 is indexed using the lower 8 bits of the PC for the application stream, where the lower 8 bits of the PC are compared 400 to the SPTEntry.pc 210 to determine whether they match 401 or not 402. If a match is found then the stride is calculated 410, where stride equals the current address minus the SPTEntry.address 211. delberg (DE).

21. Mai 2004 (1.05.2004)
(54) Title: I-UBRICATING DEVICE AN-D LUBRICATING APPARATUS CONTAINING SAID DEVICE (57) Abstract: The invention relates to a lubricatin-device, particularly for use in an apparatus which is used to lubricate mobile lubrication points e.a. on a rotating belt or chain belt and in a device accord feed pump (3) into a dosin-chamber (7) which is separated from the 15 lubricant discharge channel (6), is placed in a front standby position and, counter to the effect of a restoring force, is moved into a locking and lubricant release position wherein the link between the pump (3) and the dosina chamber (7) is blocked by a reversiii-piston (8) and z the dosin, chamber (7) is fluidicaliv connected to the lubricant discharge channel and a predefined volume of lubricant can be pumped 10 out of the dosina chamber (7) into the lubricant discharge channel. The lubricant discharge body (15′) cooperates with a reversin-piston (8) in such a way that the feed pump (3) is fluidically connected to 6 the dosing chamber (7) of a dosinl piston/cylinder arrangement (2) via an annular area (9) of the reversin, piston (8′) when the lubricant discharge body (15) is located in a front standby position, and such 5 that the dosing chamber (7) is fluidically connected to the lubricant 15 discharge channel (6) via the annular area (9) when the lubricant discharge body (15) is placed in a retracted position in which the lubricant is released, wherein the reversing piston (8) blocks the fluidic connection between the feed pump (3′) and the dosing chamber (7) and such that the amount of lubricant provided for discharge can be pumped out of the dosin,, chamber (7) in the direction of the annular the feed pump (3). prefetched cache lines. This results in cache pollution, where potentially unnecessary prefetched cache lines replace existing cache lines, thus decreasing the efficiency of the cache. Of course, the cache pollution issue decreases performance benefits realized by the cache memory.

Overcoming of cache pollution is proposed in the publication by D. F. Zucker et al., “Hardware and Software Cache Prefetching Techniques for MPEG Benchmarks,” IEEE Tran.5action.5 on Circuits and Systems for Video Technology, vol. 10, pp. 782-796, August 2000, incorporated herein by reference. In this publication series-stream (prior art FIG. 5a) and parallel-strewn (prior art FIG. 5b) caches are proposed. These approaches add a small fully associative cache structure to hold prefetched cache lines.

In the series-stream cache architecture, as shown in FIG. 5a, a strewn cache 503 is connected in series with a cache memory 501. The series-stream cache 503 is queried after a cache memory 501 miss, and is used to fill the cache memory 501 with data desired by a processor 500. If the data missed in the cache memory 501 and it is not in the strewn cache 503, it is retrieved from main memory 504 directly to the cache memory 501. New data is fetched into the stream cache only if an SPT 502 hit occurs.

The parallel-stream cache, as shown in FIG. 5b, is similar to the series-stream cache except the location of the stream cache 503 is moved from a refill path of the cache memory 501 to a position parallel to the cache memory 501. Prefetched data is brought into the stream cache 503, but is not copied into the cache memory 501. A cache access therefore searches both the cache memory 501 and the stream cache 503 in parallel. On a cache miss that cannot be satisfied from either the cache memory 501 or the stream cache 503, the data is fetched from main memory 504 directly to the cache memory resulting in processor stall cycles.

The stream cache storage capacity is shared among the different application streams in the application. As a result these stream caches do not suffer from the drawbacks as described for the stream buffer approach. In this approach, application stream detection is provided by the SPT and the storage capacity for storing of cache line data is provided by the stream cache 503.

A hardware implementation of a prefetching architecture that combines techniques from the stream buffer approach and the SPT based approach is shown in FIG. 6. In this architecture, a processor 601 is coupled to a filter circuit 602 and a data cache memory 603. A stride prediction table 604 is provided for accessing thereof by the filter circuit 602. Between a main memory 605 and the data cache, a stream cache 606 is provided. In the present embodiment, the SPT 604 as well as the data cache 603 are provided within a shared memory circuit 607.

In use of the architecture shown in FIG. 6a, the processor 601 executes an application stream. The SPT is accessed in accordance with the steps illustrated in FIG. 6b, where initially a first memory circuit 610, a SPT 611 and a cache memory circuit are provided 612. The application stream typically contains a plurality of memory access instructions, in the form of load and store instructions. When a load instruction is processed 613 by the processor, data is retrieved from either cache memory 603 or main memory 605 in dependence upon whether a cache line miss occurred in the data cache 603. When a cache line miss occurs 614 in the data cache, the SPT 604 is preferably accessed and updated 615 for determination of a stride prior to accessing of the main memory 605.

Limiting SPT access operations to when a cache line miss occurs 614, rather than for all load and store instructions, allows for an efficient implementation of both the SPT and the data cache without any significant change in performance of the system shown in FIG. 6a. Preferably, prefetched cache lines are stored in a temporary buffer, such as a stream buffer in the form of the stream cache 606 or, alternatively, are stored directly in the data cache memory 603.

By performing stream detection based on cache line miss information using the SPT, the following advantages are realized. A simple implementation of the SPT 604 is possible, since cache misses are typically not frequent, and as a result, a single ported SRAM memory is sufficient for implementing of the SPT 604. This results in a smaller chip area and reduces overall power consumption. Since the SPT is indexed with cache line miss information, the address and stride fields of the SPT entries are preferably reduced in size. For a 32-bit address space and a 64-byte cache line size, the address field size is optionally reduced to 26 bits, rather than a more conventional 32 bits. Similarly, the stride field within the SPT 212 represents a cache line stride, rather than a data reference stride, and is therefore optionally reduced in size. Furthermore, if the prefetching scheme is to be more aggressive, then it is preferable to have the prefetch counter value set to 2 instead of 3.

Implementing of a shared storage structure for the SPT and the cache memory advantageously allows for higher die area efficiency. Furthermore, to those of skill in the art it is known that stream buffers have different data processing rates and as a result having a shared storage capacity for multiple stream buffers advantageously allows for improved handling of the different stream buffer data processing rates.

Advantageously, by limiting prefetching to data cache line miss information, an efficient filter is provided that prevents unnecessary access and updates to entries within the SPT. Accessing the SPT only with miss information typically requires less entries within the SPT and furthermore does not sacrifice performance thereof. In FIG. 7a, a first pseudocode C program including a loop that provides copy functionality for copying of N entries from a second array b[i] 702 to a first array a[i] 701. In execution of the loop N times, all the entries of the second array 702 are copied to the first array 701. In FIG. 7b, a second pseudocode C program is shown that provides the same copy functionally as that shown in FIG. 7a. The first program has two application streams and therefore two SPT entries are used in conjunction with the embodiment of the invention as well as for the prior art SPT based prefetching approach. In the second program, the loop is unrolled twice, namely the loop is executed N/2 times each time performing twice the necessary operations of the fully rolled up loop and as such two copy instructions are executed within each pass of the loop. Both programs have the same two application streams and two SPT entries are used in accordance with the embodiment of the invention. Unfortunately, when executed with the prior art SPT based prefetching approach, four SPT entries are required for the unrolled loop. This is assuming of course that a cache line holds an integer multiple of 2 times a 32-bit integer sized data elements. Loop unrolling is an often used technique to reduce the loop control overhead, where the loop unrolling complicates the SPT access by necessitating more than two accesses to the SPT per loop pass executed.

In FIG. 7c, the pseudocode C program adds elements of a second array b[i] 702 to a first array a[i] 701 in dependence upon a 32 bit integer sum variable 703. Unfortunately, in using the prior are SPT based prefetching approach, regularity of data access operations may not be detected in the access pattern of the input stream b[i]. Thus when a line within the data cache holds multiple stream data elements relating to b[i], a performance increase is realized when copy functionally is performed in accordance with the embodiment of the invention, when a condition in the loop a[i]>=0 is fulfilled, at least for every cache line.

Experimentally it has been found that when an embodiment of the invention, implemented for testing the invention, was used for very large instruction word (VLIW) processors, up to 2 data references per processor clock cycle were executable and the amount of data references that missed in the data cache was closer to one out of one hundred processor clock cycles. Furthermore, the SPT implementation in accordance with the embodiment of the invention occupies a small die area when manufactured.

Numerous other embodiments may be envisaged without departing from the spirit or scope of the invention.

What is claimed is:

1. A method of data retrieval comprising the steps of: providing a first memory circuit (610); providing a stride prediction (611) table (SPT); providing cache memory circuit (612); executing instruction for accessing data (613) within the first memory; detecting a cache miss (614); and accessing and updating (615) the SPT only when a cache miss is detected.

2. A method according to claim 1 wherein the cache memory circuit is a stream buffer.

3. A method according to claim 1 wherein the cache memory circuit is a random access cache memory.

4. A method according to claim 1 wherein the cache memory circuit and the SPT are within a same physical memory space.

5. A method according to claim 1 wherein the first memory is an external memory circuit separate from a processor exectuing the instructions.

6. A method according to claim 1 wherein the step of detecting a cache miss includes the steps of: determining whether an instruction being executed by the processor is a memory access instruction; when the instruction is a memory access instruction, determining whether data at a memory location of the memory access instruction is present within the cache; and when the data is other than present within the cache, detecting a cache miss.

7. A method according to claim 1 wherein the step of detecting a cache miss includes the steps of: determining whether an instruction to be executed by the processor is a memory access instruction; when the instruction is a memory access instruction, determining whether data at a memory location of the memory access instruction is present within the cache; and, when the data is other than present within the cache, detecting a cache miss, and accessing and updating the SPT only when the cache miss has occurred.

8. A method according to claim 1, wherein the step of accessing provides a step of filtering that prevents unnecessary access and updates to entries within the SPT.

9. A method according to claim 1, wherein the cache memory circuit is integral with the processor executing the instructions.

10. A method according to claim 1, wherein the SPT comprises and address field, and where a size of the address field is less than an address space used to index the SPT.

11. An apparatus comprising: a stride prediction (604) table (SPT); and, a filter circuit (602) for use with the SPT, the filter circuit for determining instance wherein the SPT is to be accessed and updated, the instances only occurring when a cache miss is detected.

12. An apparatus according to claim 11 comprising a memory circuit, the memory circuit for storing the SPT therein.

13. An apparatus according to claim 12 comprising a cache memory, the cache memory residing within the memory circuit (605).

14. An apparatus according to claim 13, wherein the memory circuit is a single ported memory circuit.

15. A method according to claim 13, wherein the memory circuit is a random access memory circuit.

16. A method according to claim 1, wherein the cache memory circuit is a stream buffer (606).
